(19) United States
(12) Patent Application Publication
(10) Pub. No.: US 2025/0123819 A1
(43) Pub. Date: Apr. 17, 2025

(54) METHODS AND APPARATUS TO UTILIZE LARGE LANGUAGE ARTIFICIAL INTELLIGENCE MODELS TO CONVERT COMPUTER CODE

(71) Applicant: Intel Corporation, Santa Clara, CA (US)

(72) Inventors: Jyotsna Khemka, Bangalore (IN); Saurabh Tiwari, Bangalore (IN)

(73) Assignee: Intel Corporation, Santa Clara, CA (US)

(21) Appl. No.: 19/002,358

(22) Filed: Dec. 26, 2024

(30) Foreign Application Priority Data
Jul. 11, 2024 (IN) 202441053032

(51) Int. Cl. G06F 8/35; G06N 3/0895

(52) U.S. Cl. CPC G06F 8/35; G06N 3/0895

(57) ABSTRACT

Systems, apparatus, articles of manufacture, and methods are disclosed to utilize large language artificial intelligence models to convert computer code. An example apparatus includes instructions and processor circuitry to execute the instructions to at least: train a large language model based on a computer instructions repository that includes code of a first type; utilize the large language model to convert an input set of instructions of the first type into output code of a second type; cause execution of the output code; determine if the execution is successful; and when the execution is not successful, utilize the output code for fine-tuning training of the large language model with incorrect data.

### RELATED APPLICATION

This patent claims the benefit of Indian Provisional Patent Application No. 202441053032, which was filed on Jul. 11, 2024. Indian Provisional Patent Application No. 202441053032 is hereby incorporated herein by reference in its entirety. Priority to Indian Provisional Patent Application No. 202441053032 is hereby claimed.

### BACKGROUND

Many data-centric workloads run best when deployed across a mix of architectures. Common architectures include central processing unit (CPU), graphics processing unit (GPU), field programmable gate array (FPGA), dedicated accelerators such as artificial intelligence (AI) accelerator, etc. Different architectures may utilize unique languages, tools, and libraries. For example, a particular GPU may operate based on a proprietary programming language and environment.

### BRIEF DESCRIPTION OF THE DRAWINGS

FIG. 1 is a block diagram of an example environment in which an example translation circuitry operates to translate computer code from one type to another.

FIG. 2 is a block diagram of an example implementation of the translation circuitry of FIG. 1.

FIGS. 3-4 are flowcharts representative of example machine readable instructions and/or example operations that may be executed, instantiated, and/or performed by example programmable circuitry to implement the translation circuitry of FIG. 2.

FIGS. 5-6 are block diagrams illustrating example approaches for code translation and validation.

FIG. 7 is a block diagram of an example processing platform including programmable circuitry structured to execute, instantiate, and/or perform the example machine readable instructions and/or perform the example operations of FIGS. 3-4 to implement the translation circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 3-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In the past, different types of accelerators were programmed using different languages and libraries, leading to maintaining separate code bases, and forcing developers to program within vendor-specific walled gardens. In addition, inconsistent tools support across platforms meant developers have to spend time learning different sets of tools. That means that developing software for each hardware platform may take a separate investment, with little ability to reuse that work to target a different architecture.

In today's world, there are many challenges in using diverse hardware. Developers use multiple programming languages/models/tools to use heterogeneous architectures. There are different programming languages for CPU/GPU/FPGA or other accelerators, which do not allow for a single code base to run on any given platform architecture. One such example is, Compute Unified Device Architecture (CUDA), which is a specialized/proprietary programming language used in programming for some GPUs.

To achieve high performance and efficient developer productivity across CPU, GPU, FPGA, and other architectures, developers could use a unified programming model that enables them to select the optimal hardware for the task at hand without being stuck with a platform based on a programming model. For example, a high-level, open standard, heterogeneous programming language could be built on standards and extensible. It may boost developer productivity while providing consistent performance across architectures. An example standard for unified application programming is known as oneAPI which was an initiative from INTEL® and currently run by the Unified Acceleration (UXL) Open source foundation. oneAPI provides an open, standards-based, multiarchitecture programming model that provides freedom of choice across accelerators while maximizing developer productivity. Based on standards, oneAPI simplifies development and delivers performance and productivity for accelerated compute without proprietary programming lock-in. With oneAPI, developers can choose the best architecture for the problem they are trying to solve without needing to rewrite software for the next architecture or platform. oneAPI is based on ISO C++ and Khronos Group's SYCL*, a C++-based Khronos Group standard, addresses these challenges by extending C++ capabilities to support multiarchitecture and disjoint memory configurations. SYCL is an open standard based unified/universal programming abstraction that enables use on heterogeneous devices, to be used in a single application—for example simultaneous use of CPUs, GPUs, and FPGAs.

To take advantage of the benefits of a universal, unified, heterogeneous, etc. programming model, developers would benefit from an accurate and reliable approach for converting code from a specialized programming language into code that utilizes a universal programming language.

A large language model (LLM) is a computational model that is suited for general-purpose language generation and other natural language processing tasks such as classification. LLMs learn statistical relationships from repositories of text during training (e.g., self-supervised and semi-supervised training processes). Large Language models are predominantly used in a variety of natural language processing (NLP) tasks such as generating and classifying text, answering questions in a conversational manner, and translating text from one language to another.

Methods and apparatus disclosed herein utilize large language model (LLM) artificial intelligence (AI) to convert code from one type to another. For example, the proposed methods and apparatus may convert code from a proprietary, vendor specific, device specific, etc. programming language/architecture to an open standard programming language/architecture such as, for example, oneAPI. In another example, methods and apparatus disclosed herein may utilize LLM based source to source translation/conversion/migration of a vendor specific low-level machine code (e.g., CUDA) to high level universal code (e.g., SYCL), which can be targeted for heterogenous architectures. For example, in some implementations, translation may be performed with 99% migration accuracy, which will enhance developer's productivity.

Methods and apparatus disclosed herein include training an LLM. For full training of a selected LLM, repositories such as opensource CUDA/HIP repositories available in the world wide web may be utilized as training information to provide large amounts of CUDA/HIP API code for learning. Once the LLM has been trained, the methods and apparatus include fine tuning the LLM for a specific need and for better accuracy. For example, fine tuning may be performed using existing open source SYCL repositories along with the new migrated SYCL code which had been generated using this LLM models. In some examples, fine turning is performed in two parts:
1. Fine tuning with correct data; and
2. Fine tuning with incorrect data (so that the model does not produce the wrong output again).

The example methods and apparatus utilize Large Language Models for generating unified code for heterogenous architecture from low-level machine code. The LLM model is utilized to fully train on available code (e.g., opensource code available on CUDA, HIP and SYCL). Once the model is trained and run on various other code (e.g., other CUDA/HIP code and generated SYCL output), the methods and apparatus check for the correctness of the generated code and fine tune the LLM. A fine-tuned large language model offers more accurate and precise responses, reducing errors and misunderstandings.

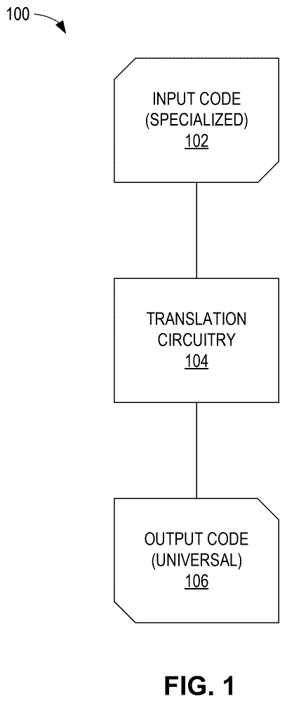

FIG. 1 is a block diagram of an example environment in which an example input code 102 is translated by an example translation circuitry 104 into an output code 106.

The example input code 102 is a specialized code that is proprietary to a particular vendor's hardware (e.g., CUDA). Alternatively, the input code 102 may be any type of code that a user would like to translate. The example input code 102 may be an entire application and/or may be portion of an application (e.g., a function, a module, a library, etc.).

The example translation circuitry 104 of the illustrated example utilizes an artificial intelligence model (e.g., a large language model) to translate the input code 102 into the output code 106. The example translation circuitry 104 utilizes an LLM to generate the output code 106 as unified code for heterogenous architecture from the input code 102 that is low-level machine code. Alternatively, the translation circuitry 104 may operate to convert any type of input code to any type of output code. The LLM model of the translation circuitry 104 is trained (e.g., fully trained) on opensource code available for the type of the input code 102 and the type of the output code 106 (e.g., CUDA code repositories, Heterogeneous-computing Interface for Portability (HIP) code repositories, SYCL code repositories, etc. In addition to performing a conversion using the LLM, the translation circuitry 104, analyzes the output code to check for the correctness of the generated code and to perform fine tuning of the LLM (e.g., to reinforce code outputs that is correct, that compiles, that is executable, etc. and to negatively reinforce code outputs that are incorrect, that do not compile, that do not execute, etc.).

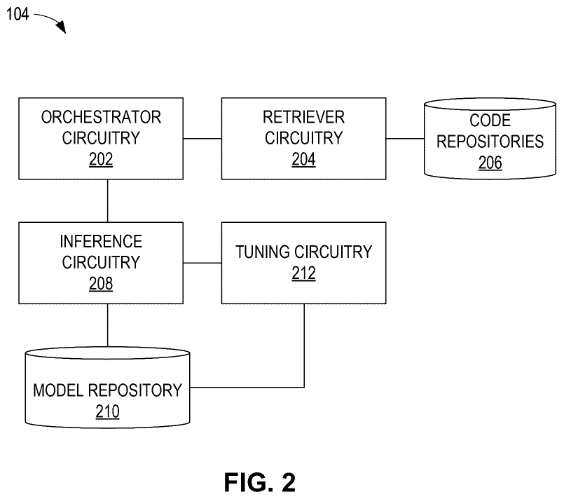

The translation circuitry 104 of the illustrated example, is implemented by software executing on a processing device. Alternatively, as described herein, the translation circuitry 104 may be implemented by any combination of software and/or hardware. Further details are described in conjunction with the example implementation of the translation circuitry 104 illustrated in FIG. 2.

The example output code 106 is a unified heterogenous code that can be executed on a variety of hardware platforms and/or hardware from a variety of vendors (e.g., SYCL). Alternatively, the input code 102 may be any type of code that a user would like to translate. The example input code 102 may be an entire application and/or may be portion of an application (e.g., a function, a module, a library, etc.).

FIG. 2 is a block diagram of an example implementation of the translation circuitry of FIG. 1 to do translate input code of one type (e.g., of a particular language, protocol, structure, etc.) into an output code of another type. The translation circuitry of FIG. 2 may be instantiated (e.g., creating an instance of, bring into being for any length of time, materialize, implement, etc.) by programmable circuitry such as a Central Processor Unit (CPU) executing first instructions. Additionally or alternatively, the translation circuitry of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example translation circuitry 104 of FIG. 2 includes an example orchestrator circuitry 202, an example retriever circuitry 204, example code repositories 206, an example inference circuitry 208, an example model repository 210, and an example tuning circuitry 212.

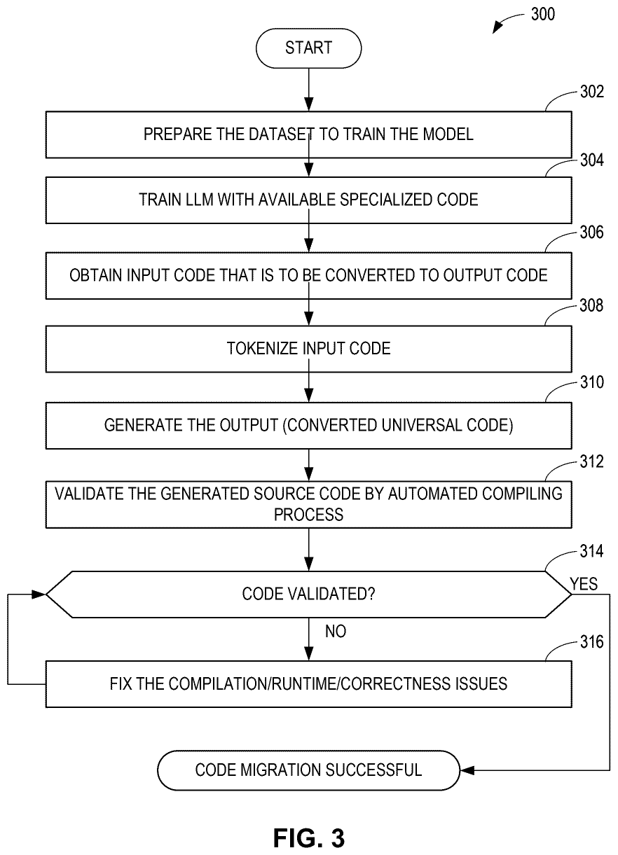

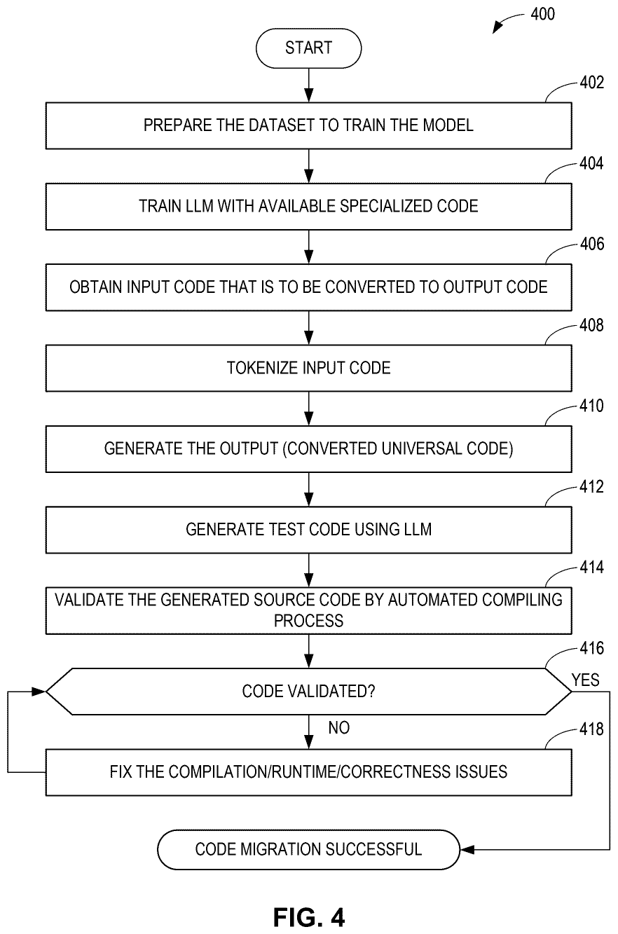

The example orchestrator circuitry 202 obtains the input code 102 and controls the translation of the input code 102 into the output code 106. In some examples, the orchestrator circuitry 202 is instantiated by programmable circuitry executing orchestration instructions and/or configured to perform operations such as those represented by the flowchart(s) of FIGS. 3-4.

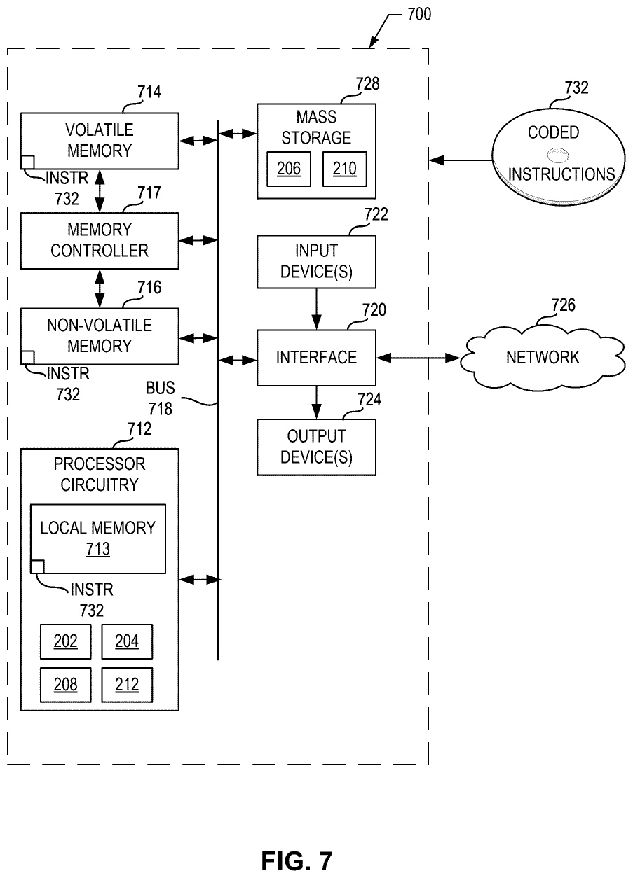

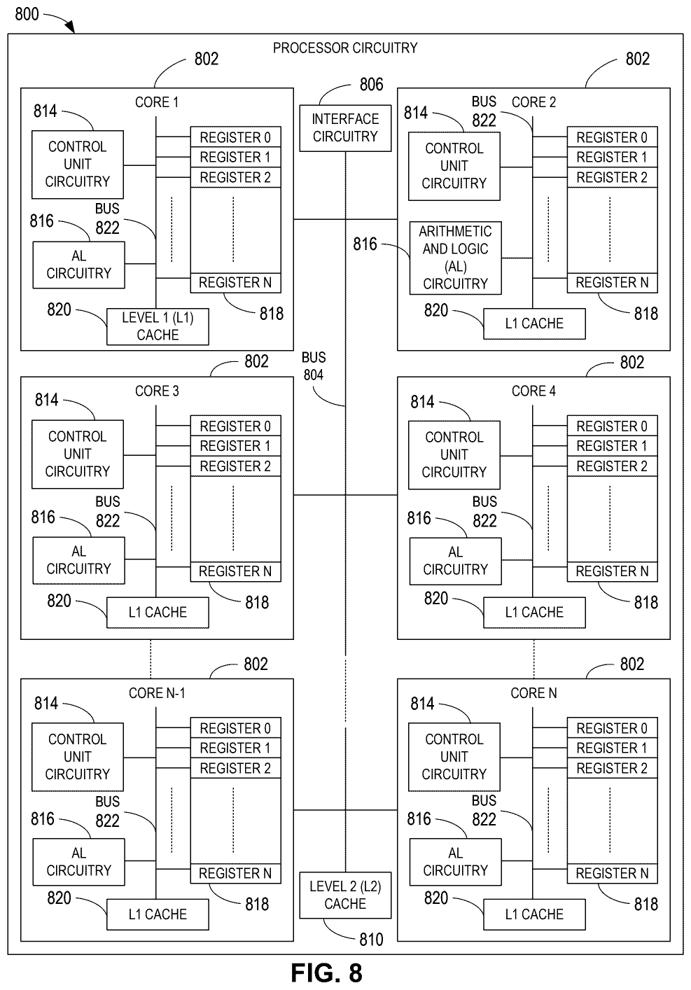

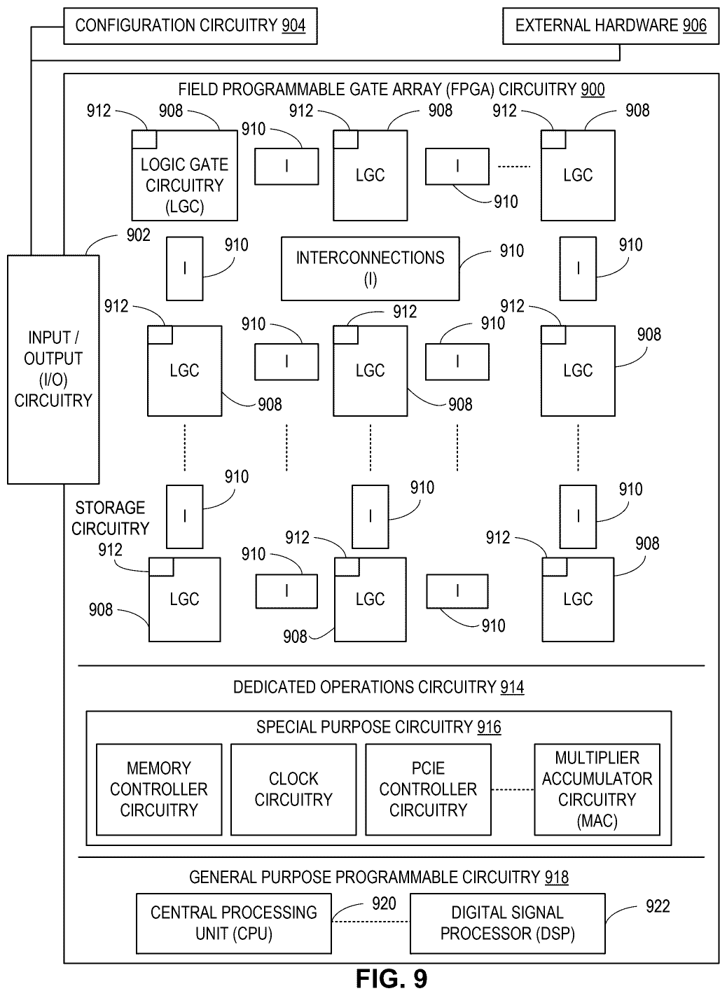

In some examples, the orchestrator circuitry 202 includes means for orchestration. For example, the means for orchestration may be implemented by the orchestrator circuitry 202. In some examples, the orchestrator circuitry 202 may be instantiated by programmable circuitry such as the example programmable circuitry 712 of FIG. 7. For instance, the orchestrator circuitry 202 may be instantiated by the example microprocessor 800 of FIG. 8 executing machine executable instructions such as those implemented by at least blocks 304 of FIG. 3 and 404 of FIG. 4. In some examples, the orchestrator circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the orchestrator circuitry 202 may be instantiated by any other combination of hardware, software, and/or firmware. For example, the orchestrator circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example retriever circuitry 204 retrieves code data from repositories such as the code repositories 206 for use in model training and fine-tuning as instructed by the orchestrator circuitry 202. In some examples, the retriever circuitry 204 is instantiated by programmable circuitry executing orchestration instructions and/or configured to perform operations such as those represented by the flowchart(s) of FIGS. 3-4.

In some examples, the translation circuitry 104 includes means for retrieving. For example, the means for retrieving may be implemented by the retriever circuitry 204. In some examples, the retriever circuitry 204 may be instantiated by programmable circuitry such as the example programmable circuitry 712 of FIG. 7. For instance, the retriever circuitry 204 may be instantiated by the example microprocessor 800 of FIG. 8 executing machine executable instructions such as those implemented by at least blocks 302 of FIG. 3 and 402 of FIG. 4. In some examples, the retriever circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the retriever circuitry 204 may be instantiated by any other combination of hardware, software, and/or firmware. For example, the retriever circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The code repositories 206 of the illustrated example are code repositories that include example code of the type utilized by the input code 102 and the output code 106. The example code repositories 206 are local code repositories of the translation circuitry 104 that are implemented by a database. Alternatively, the code repositories may be any combination of local and/or remote code repositories of any type (e.g., files, folders, disk storage, flash storage, etc.). For example, the code repositories 206 may include publicly available code repositories (e.g., open source code repositories). The code repositories 206 may include repositories that include correlations of code of one type and code of a second type (e.g., repositories that indicate that a first code of a first type is equivalent to a second code of a second type).

The example inference circuitry 208 utilizes a large language model obtained from the model repository 210 to convert the input code 102 into the output code 106. In some examples, the inference circuitry 208 is instantiated by programmable circuitry executing orchestration instructions and/or configured to perform operations such as those represented by the flowchart(s) of FIGS. 3-4.

In some examples, the translation circuitry 104 includes means for inferring. For example, the means for inferring may be implemented by the inference circuitry 208. In some examples, the inference circuitry 208 may be instantiated by programmable circuitry such as the example programmable circuitry 712 of FIG. 7. For instance, the inference circuitry 208 may be instantiated by the example microprocessor 800 of FIG. 8 executing machine executable instructions such as those implemented by at least blocks 308-310 of FIG. 3 and 408-410 of FIG. 4. In some examples, the inference circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the inference circuitry 208 may be instantiated by any other combination of hardware, software, and/or firmware. For example, the inference circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example model repository 210 is a database that stores retrieved, trained, and/or fine tuned artificial intelligence models (e.g., large language models). While the example model repository 210 is local to the translation circuitry 104, the model repository 210 may include one or more local and/or remote (e.g., cloud hosted) repositories.

The example tuning circuitry 212 analyzes output results of the inference circuitry 208 to perform fine tuning. For example, the tuning circuitry 212 may validate the output results by attempting to compile, execute, and/or test the output results. Based on the results of the validating, the tuning circuitry 212 may reinforce and/or positively train on valid/correct results and may negatively train on invalid/incorrect results. In some examples, the tuning circuitry 212 is instantiated by programmable circuitry executing orchestration instructions and/or configured to perform operations such as those represented by the flowchart(s) of FIGS. 3-4.

In some examples, the translation circuitry 104 includes means for tuning. For example, the means for tuning may be implemented by the tuning circuitry 212. In some examples, the tuning circuitry 212 may be instantiated by programmable circuitry such as the example programmable circuitry 712 of FIG. 7. For instance, the tuning circuitry 212 may be instantiated by the example microprocessor 800 of FIG. 8 executing machine executable instructions such as those implemented by at least blocks 312-316 of FIG. 3 and 412-418 of FIG. 4. In some examples, the tuning circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the tuning circuitry 212 may be instantiated by any other combination of hardware, software, and/or firmware. For example, the tuning circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the translation circuitry of FIG. 1 is illustrated in FIG. 2, one or more of the elements, processes, and/or devices illustrated in FIG. 2 may be combined, divided, re-arranged, omitted, eliminated, and/or implemented in any other way. Further, the example orchestrator circuitry 202, the example retriever circuitry 204, the example inference circuitry 208, the example tuning circuitry 212, and/or, more generally, the example translation circuitry 104 of FIG. 2, may be implemented by hardware alone or by hardware in combination with software and/or firmware. Thus, for example, any of the example orchestrator circuitry 202, the example retriever circuitry 204, the example inference circuitry 208, the example tuning circuitry 212, and/or, more generally, the example translation circuitry 104, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example translation circuitry 104 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the translation circuitry 104 of FIG. 2 and/or representative of example operations which may be performed by programmable circuitry to implement and/or instantiate the translation circuitry 104 of FIG. 2, are shown in FIGS. 3-4. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-4, many other methods of implementing the example translation circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to utilize a large language model to translate code from one type to another. The example machine-readable instructions and/or the example operations 300 of FIG. 3 begin at block 302, at which the retriever circuitry 204 prepares a dataset to train a large language model (block 302). For example, the dataset may be code that is retrieved from the code repositories 206.

The example orchestrator 202 causes the inference circuitry 208 to train a large language model using available code (e.g., specialized code such as CUDA code) (block 304). The example orchestrator 202 obtains input code that is to be converted to output code (block 306).

The example inference circuitry 208 tokenizes the input code (block 308). For example, the inference circuitry 208 may associate a token with each word/command of the input code. Then, the example inference circuitry 208 analyzes the tokenized input code to generate the output code (e.g., converted universal code) (block 310).

The example tuning circuitry 212 validates the generated output by attempting to compile the output code (block 312). If the tuning circuitry 212 determines that the code is validated (block 314), the code translation is successful. Alternatively, if the output code is not validated (block 314), the tuning circuitry 212 performs fine tuning of the large language model (e.g., reinforces correct code and negatively tunes incorrect code) (block 316). Control then returns to block 314 to loop until validated code is output.

FIG. 4 is a flowchart representative of example machine readable instructions and/or example operations 400 that may be executed, instantiated, and/or performed by programmable circuitry to utilize a large language model to translate code from one type to another. The example machine-readable instructions and/or the example operations 400 of FIG. 4 begin at block 402, at which the retriever circuitry 204 prepares a dataset to train a large language model (block 402). For example, the dataset may be code that is retrieved from the code repositories 206.

The example orchestrator 202 causes the inference circuitry 208 to train a large language model using available code (e.g., specialized code such as CUDA code) (block 404). The example orchestrator 202 obtains input code that is to be converted to output code (block 406).

The example inference circuitry 208 tokenizes the input code (block 408). For example, the inference circuitry 208 may associate a token with each word/command of the input code. Then, the example inference circuitry 208 analyzes the tokenized input code to generate the output code (e.g., converted universal code) (block 410).

The example inference circuitry 212 generates automated test cases to be applied to the output code (block 412). The example tuning circuitry 212 validates the generated output by attempting to compile the output code and to applied the automated test cases (block 414). If the tuning circuitry 212 determines that the code is validated (block 416), the code translation is successful. Alternatively, if the output code is not validated (block 416), the tuning circuitry 212 performs fine tuning of the large language model (e.g., reinforces correct code and negatively tunes incorrect code) (block 418). Control then returns to block 416 to loop until validated code is output.

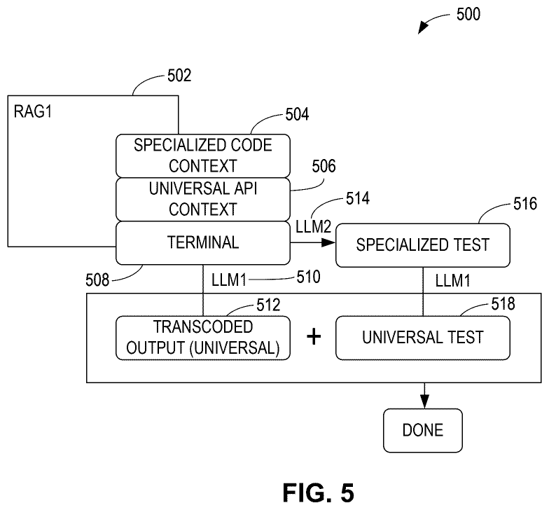

FIG. 5 is a block diagram illustrating an example approach 500 for code translation and validation. According to the illustrated example, Retrieval-Augmented Generation (RAG) 502 is utilized to improve the accuracy of the large language model(s) by augmenting the pre-trained LLM with example code data (e.g., code data retrieved from the code repositories 206 or any other source. According to the illustrated example, fully detailed information about the code to be converted is provided as the specialized code context 504. For example, the context may include information about objects, variables, functions, etc. that are a part of the input code. In addition, a universal application programming interface (API) context 506 is included that provides a context for an API that is associated with the output code type.

The computing terminal 508 is an example user environment in which the translation may be performed (e.g., a terminal console). The example terminal 508 may be utilized to execute a first LLM 510 to perform a translation/transcoding of the input specialized code 504 into the transcoded universal output code 512. For example, the first LLM 510 may convert CUDA code into SYCL code. The terminal 508 may additionally be utilized to execute a second LLM 514 to generate a specialized code test 516 that may be converted by the first LLM 510 to a universal code test 518. For example, the second LLM 514 may generate a test for CUDA code and the first LLM 510 may convert the specialized CUDA code test to a universal code test.

As described in conjunction with FIGS. 3-4, the output universal code may be tested utilized the universal test 518 and fine tuning of the first LLM 510 may be performed until the output code 512 is validated.

According to the example approach 500 illustrated in FIG. 5, the project contains thorough definition information such as information about objects, variables, and functions of the input code. Thus, all of the information for operating the LLM may be gathered in a single prompt of the LLM. Further, according to the example, the first LLM 510 is to transcode specialized code (e.g., CUDA) into universal, heterogeneous code (e.g., SYCL). The first LLM 510 may be fine tuned for generating the universal heterogeneous code. The second LLM 514 is fine tuned to handle the specialized code (e.g., CUDA code). The RAG 502 may find documentation and API information for code of the second type (e.g., the SYCL code).

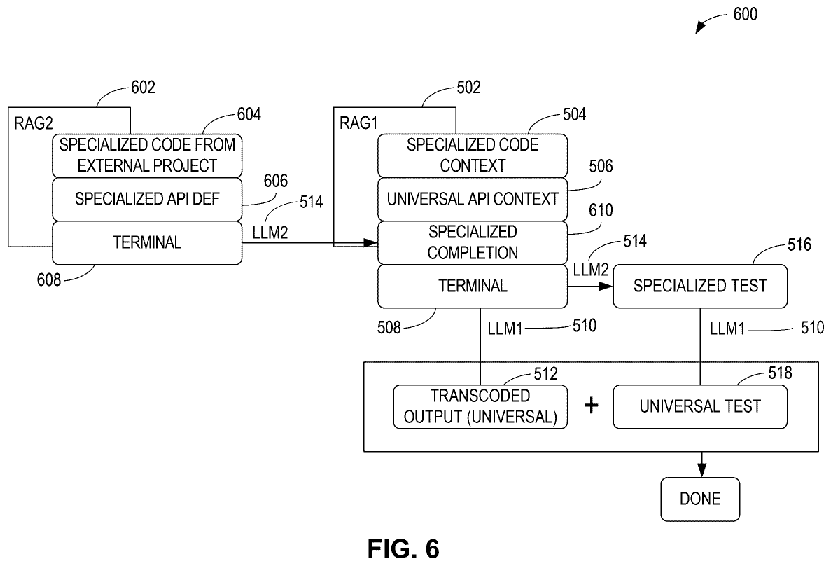

FIG. 6 is a block diagram illustrating another example approach 600 for code translation and validation. The example approach 600 includes several of the same components as FIG. 5, which are numbered the same as FIG. 5 and are not described further. However, the example approach 600 additionally includes a second RAG 602 that may be utilized in conjunction with specialized code from external projects 604 and a specialized API definition 606 (e.g., a definition of an API associated with CUDA) so that the terminal 608 can generate a specialized completion 610 (e.g., a CUDA completion). For example, the second LLM 514 may be utilized to generate missing API code in CUDA and then transcode the generated code to SYCL.

In some implementations of the approach 600, the project may not contain all required definition information. For example, the project may be missing one or more of object, variable, function information, API information, etc. In such an example, the specialized code (e.g., CUDA) may be utilized as an intermediate language. For example, if there is more data available for the specialized code. In such an example, the second RAG 602 may be utilized to search for specialized code and corresponding API information.

FIG. 7 is a block diagram of an example programmable circuitry platform 700 structured to execute and/or instantiate the example machine-readable instructions and/or the example operations of FIGS. 3-4 to implement the translation circuitry 104 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example orchestrator circuitry 202, the example retriever circuitry 204, the example inference circuitry 208, the example tuning circuitry 212.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. The example mass storage 728 includes the code repositories 206 and the model repository 210.

The machine readable instructions 732, which may be implemented by the machine readable instructions of FIGS. 3-4, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 3-4 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 3-4.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 3-4 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-4. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-4. As such, the FPGA circuitry 900 may be configured and/or structured to effectively instantiate some or all of the operations/functions corresponding to the machine readable instructions of the flowchart(s) of FIGS. 3-4 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 3-4 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 3-4 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 3-4 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 3-4, and/or an ASIC may be configured and/or structured to perform third operation(s)/function(s) corresponding to a third portion of the machine readable instructions represented by the flowcharts of FIGS. 3-4.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

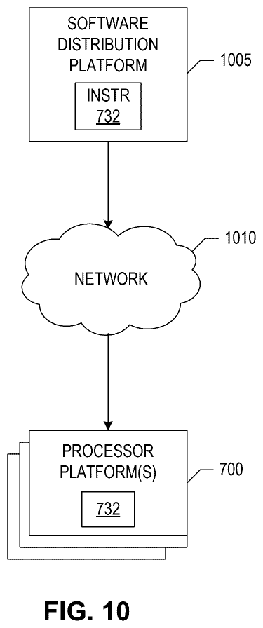

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 3-4, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 3-4, may be downloaded to the example programmable circuitry platform 700, which is to execute the machine readable instructions 732 to implement the translation circuitry. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that utilize large language models to convert computer code. Disclosed systems, apparatus, articles of manufacture, and methods improve the efficiency of using a computing device by improving the accuracy of code conversion and enabling a computing device to translate code from one code type to another while validating the results of the output to confirm that they can be compiled and executed. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to utilize large language artificial intelligence models to convert computer code are disclosed herein. Further examples and combinations thereof include the following:

Example 1 includes At least one non-transitory machine-readable medium comprising machine-readable instructions to cause at least one processor circuit to at least train a large language model based on a computer instructions repository that includes code of a first type, utilize the large language model to convert an input set of instructions of the first type into output code of a second type, cause execution of the output code, determine if the execution is successful, and when the execution is not successful, utilize the output code for fine-tuning training of the large language model with incorrect data. perform tuning of the large language model based on the output code.

Example 2 includes the at least one non-transitory machine-readable medium of example 1, wherein the instructions, when executed, cause the at least one processor circuit to utilize Retrieval-Augmented Generation to access a datastore of computer instructions to convert the input set of instructions.

Example 3 includes the at least one non-transitory machine-readable medium of any foregoing example, wherein the first type is a vendor-specific programming language and the second type is a programming language supported by multiple vendor devices.

Example 4 includes the at least one non-transitory machine-readable medium of any foregoing example, wherein the instructions, when executed, cause the at least one processor circuit to utilize a second large language model to generate the input set of instructions.

Example 5 includes the at least one non-transitory machine-readable medium of any foregoing example, wherein the tuning includes adjusting a number of tokens utilized by the large language model.

Example 6 includes the at least one non-transitory machine-readable medium of any foregoing example, wherein the instructions, when executed, cause the at least one processor circuit to tokenize the input set of instructions.

Example 7 includes the at least one non-transitory machine-readable medium of any foregoing example, when the execution is successful, output the output code.

Example 8 includes an apparatus comprising instructions, processor circuitry to execute the instructions to at least train a large language model based on a computer instructions repository that includes code of a first type, utilize the large language model to convert an input set of instructions of the first type into output code of a second type, cause execution of the output code, determine if the execution is successful, and when the execution is not successful, utilize the output code for fine-tuning training of the large language model with incorrect data.

Example 9 includes the apparatus of example 8, wherein the processor circuitry is to utilize Retrieval-Augmented Generation to access a datastore of computer instructions to convert the input set of instructions.

Example 10 includes the apparatus of any foregoing example, wherein the first type is a vendor-specific programming language and the second type is an open source programming language.

Example 11 includes the apparatus of any foregoing example, wherein the processor circuitry is to utilize a second large language model to generate the input set of instructions.

Example 12 includes the apparatus of any foregoing example, wherein the tuning includes adjusting a number of tokens utilized by the large language model.

Example 13 includes the apparatus of any foregoing example, wherein the processor circuitry is to, when the execution is successful, output the output code.

Example 14 includes a method comprising training a large language model based on a computer instructions repository that includes code of a first type, utilizing the large language model to convert an input set of instructions of the first type into output code of a second type, causing execution of the output code, determining if the execution is successful, and when the execution is not successful, utilizing the output code for fine-tuning training of the large language model with incorrect data. perform tuning of the large language model based on the output code.

Example 15 includes the method of example 14, wherein the instructions, when executed, cause the at least one processor circuit to utilize Retrieval-Augmented Generation to access a datastore of computer instructions to convert the input set of instructions.

Example 16 includes the method of any foregoing example, wherein the first type is a vendor-specific programming language and the second type is a programming language supported by multiple vendor devices.

Example 17 includes the method of any foregoing example, wherein the instructions, when executed, cause the at least one processor circuit to utilize a second large language model to generate the input set of instructions.

Example 18 includes the method of any foregoing example, wherein the tuning includes adjusting a number of tokens utilized by the large language model.

Example 19 includes the method of any foregoing example, wherein the instructions, when executed, cause the at least one processor circuit to tokenize the input set of instructions.

Example 20 includes the method of any foregoing example, further comprising, when the execution is successful, outputting the output code.

It is noted that this patent claims priority from IN patent application No. 202441053032, which was filed on Jul. 11, 2024, and is hereby incorporated by reference in its entirety.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable medium comprising machine-readable instructions to cause at least one processor circuit to at least:
train a large language model based on a computer instructions repository that includes code of a first type;
utilize the large language model to convert an input set of instructions of the first type into output code of a second type;
cause execution of the output code;
determine if the execution is successful; and
when the execution is not successful, utilize the output code for fine-tuning training of the large language model with incorrect data perform tuning of the large language model based on the output code.

2. The at least one non-transitory machine-readable medium of claim 1, wherein the instructions, when executed, cause the at least one processor circuit to utilize Retrieval-Augmented Generation to access a datastore of computer instructions to convert the input set of instructions.

3. The at least one non-transitory machine-readable medium of claim 1, wherein the first type is a vendor-specific programming language and the second type is a programming language supported by multiple vendor devices.

4. The at least one non-transitory machine-readable medium of claim 1, wherein the instructions, when executed, cause the at least one processor circuit to utilize a second large language model to generate the input set of instructions.

5. The at least one non-transitory machine-readable medium of claim 1, wherein the tuning includes adjusting a number of tokens utilized by the large language model.

6. The at least one non-transitory machine-readable medium of claim 1, wherein the instructions, when executed, cause the at least one processor circuit to tokenize the input set of instructions.

7. The at least one non-transitory machine-readable medium of claim 1, when the execution is successful, output the output code.

8. An apparatus comprising:
instructions;
processor circuitry to execute the instructions to at least:
train a large language model based on a computer instructions repository that includes code of a first type;
utilize the large language model to convert an input set of instructions of the first type into output code of a second type;
cause execution of the output code;
determine if the execution is successful; and
when the execution is not successful, utilize the output code for fine-tuning training of the large language model with incorrect data.

9. The apparatus of claim 8, wherein the processor circuitry is to utilize Retrieval-Augmented Generation to access a datastore of computer instructions to convert the input set of instructions.

10. The apparatus of claim 8, wherein the first type is a vendor-specific programming language and the second type is an open source programming language.

11. The apparatus of claim 8, wherein the processor circuitry is to utilize a second large language model to generate the input set of instructions.

12. The apparatus of claim 8, wherein the tuning includes adjusting a number of tokens utilized by the large language model.

13. The apparatus of claim 8, wherein the processor circuitry is to, when the execution is successful, output the output code.

14. A method comprising:
training a large language model based on a computer instructions repository that includes code of a first type;
utilizing the large language model to convert an input set of instructions of the first type into output code of a second type;
causing execution of the output code;
determining if the execution is successful; and
when the execution is not successful, utilizing the output code for fine-tuning training of the large language model with incorrect data perform tuning of the large language model based on the output code.

15. The method of claim 14, wherein the instructions, when executed, cause the at least one processor circuit to utilize Retrieval-Augmented Generation to access a datastore of computer instructions to convert the input set of instructions.

16. The method of claim 14, wherein the first type is a vendor-specific programming language and the second type is a programming language supported by multiple vendor devices.

17. The method of claim 14, wherein the instructions, when executed, cause the at least one processor circuit to utilize a second large language model to generate the input set of instructions.

18. The method of claim 14, wherein the tuning includes adjusting a number of tokens utilized by the large language model.

19. The method of claim 14, wherein the instructions, when executed, cause the at least one processor circuit to tokenize the input set of instructions.

20. The method of claim 14, further comprising, when the execution is successful, outputting the output code.
